(19) United States
(12) Patent Application Publication
(10) Pub. No.: US 2026/0054841 A1
(43) Pub. Date: Feb. 26, 2026

(54) VEHICLE WITH SPRAY ASSIST SYSTEM

(71) Applicant: Oshkosh Corporation, Oshkosh, WI (US)

(72) Inventor: Jonathan Honig, Oshkosh, WI (US)

(73) Assignee: Oshkosh Corporation, Oshkosh, WI (US)

(21) Appl. No.: 19/306,705

(22) Filed: Aug. 21, 2025

Related U.S. Application Data
(60) Provisional application No. 63/685,974, filed on Aug. 22, 2024.

(51) Int. Cl. B64D 15/10; B05B 12/00; B05B 15/68

(52) U.S. Cl. CPC B64D 15/10; B05B 12/00; B05B 15/68

(57) ABSTRACT

A vehicle can include a chassis. The vehicle can include a body that can be supported by the chassis. The vehicle can include a tractive assembly. The vehicle can include a sprayer assembly that can apply a de-icing liquid to an airplane. The vehicle can include one or more sensors that can acquire data regarding an area of the airplane. The vehicle can include a display device. The vehicle can include a controller. The controller can determine a position of the sprayer assembly relative to the area of the airplane. The controller can cause the display device of the vehicle to present a user interface that includes a graphical representation of where the sprayer assembly will spray the de-icing liquid based on the position of the sprayer assembly relative to the area of the airplane.

### CROSS-REFERENCE TO RELATED PATENT APPLICATION

This application claims the benefit of and priority to U.S. Provisional Patent Application No. 63/685,974, filed Aug. 22, 2024, the entirety of which is incorporated by reference herein.

### BACKGROUND

A vehicle can include a de-icing bucket to spray an airplane.

### SUMMARY

One embodiment relates to a vehicle for de-icing an airplane. The vehicle can include a chassis. The vehicle can include a body that can be supported by the chassis. The vehicle can include a tractive assembly. The vehicle can include a sprayer assembly that can apply a de-icing liquid to the airplane. The vehicle can include one or more sensors that can acquire data regarding an area of the airplane. The vehicle can include a display device. The vehicle can include a controller. The controller can determine a position of the sprayer assembly relative to the area of the airplane. The controller can cause the display device of the vehicle to present a user interface that includes a graphical representation of where the sprayer assembly will spray the de-icing liquid based on the position of the sprayer assembly relative to the area of the airplane.

One embodiment relates to a vehicle. The vehicle can include a turntable. The vehicle can include a lift arm that is movably coupled with the turntable. The vehicle can include a sprayer assembly that is movably coupled with the lift arm. The sprayer assembly can apply a de-icing liquid to an airplane. The vehicle can include a controller. The controller can determine a position of the sprayer assembly relative to an area of the airplane. The controller can cause a display device to present a user interface that includes a graphical representation of where the sprayer assembly will spray the de-icing liquid based on the position of the sprayer assembly relative to the area of the airplane.

One embodiment relates to a de-icing system. The de-icing system can include a sprayer assembly that can be movably coupled with a lift arm of a vehicle. The sprayer assembly can apply a de-icing liquid to an airplane. The de-icing system can include a controller. The controller can determine a position of the sprayer assembly relative to an area of the airplane. The controller can cause a display device to present a user interface that includes a graphical representation of where the sprayer assembly will spray the de-icing liquid based on the position of the sprayer assembly relative to the area of the airplane.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a de-icing vehicle, according to an exemplary embodiment.

FIG. 2 is a perspective view of the de-icing vehicle of FIG. 1 performing a de-icing operation on an airplane, according to an exemplary embodiment.

FIG. 3 is a field of view from within a bucket of the de-icing vehicle of FIG. 1, according to an exemplary embodiment.

FIG. 4 is a block diagram of a control system of the de-icing vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

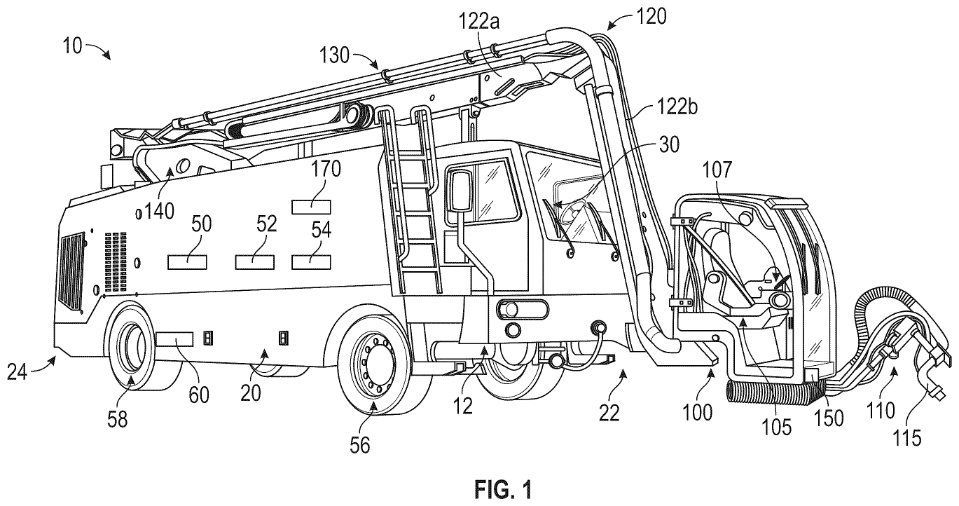

As shown in FIG. 1, a vehicle (e.g., a truck, an access equipment vehicle, a tanker, a boom truck, etc.), shown as deicer 10, is configured to clear and/or remove ice or other frozen substances from an airplane. According to an exemplary embodiment, the deicer 10 operates to spray or otherwise apply melting liquids or other possible applications to clear or remove ice from an airplane.

As shown in FIG. 1, the deicer 10 includes a chassis, shown as frame 12; a body assembly, shown as body 20, coupled to the frame 12 and having an occupant portion or section, shown as cab 30; a drivetrain, shown as driveline 50, coupled to and/or supported by the frame 12; a braking assembly, shown as braking system 60, coupled to one or more components of the driveline 50 to facilitate selectively braking the one or more components of the driveline 50; a de-icing system, shown as de-icing system 100; and/or a vehicle assist system, shown as controller 170, coupled to the driveline 50, the braking system 60, and the de-icing system 100. In some embodiments, the deicer 10 includes more or fewer components.

As shown in FIG. 1, the deicer 10 has a first end, shown as front end 22, a second end, shown as rear end 24, opposite the front end 22. The de-icing system 100 is shown positioned and/or disposed at the front end 22 of the deicer 10 (e.g., in front of the cab 30).

According to an exemplary embodiment, the driveline 50 is configured to propel the deicer 10. As shown in FIG. 1, the driveline 50 includes a primary driver, shown as prime mover 52, an energy storage device, shown as energy storage 54, a first tractive assembly (e.g., axles, wheels, tracks, differentials, etc.), shown as front tractive assembly 56, and a second tractive assembly (e.g., axles, wheels, tracks, differentials, etc.), shown as rear tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment, shown in FIG. 1, the front tractive assembly 56 includes front tractive elements and the rear tractive assembly 58 includes rear tractive elements that are configured as wheels. In some embodiments, the front tractive elements and/or the rear tractive elements are configured as tracks.

According to an exemplary embodiment, the prime mover 52 is configured to provide power to drive the front tractive assembly 56 and/or the rear tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the front tractive assembly 56 and/or the rear tractive assembly 58. The front tractive assembly 56 and/or the rear tractive assembly 58 may include a drive shaft, a differential, and/or an axle. In some embodiments, the front tractive assembly 56 and/or the rear tractive assembly 58 include two axles or a tandem axle arrangement. In some embodiments, the front tractive assembly 56 and/or the rear tractive assembly 58 are steerable (e.g., using a steering wheel of the deicer 10). In some embodiments, both the front tractive assembly 56 and the rear tractive assembly 58 are fixed and not steerable (e.g., employ skid steer operations).

In some embodiments, the driveline 50 includes a plurality of prime movers 52. By way of example, the driveline 50 may include a first prime mover 52 that drives the front tractive assembly 56 and a second prime mover 52 that drives the rear tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 56, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 58, a second prime mover 52 that drives a first one of the front tractive elements, and a third prime mover 52 that drives a second one of the front tractive elements.

In some embodiments, the deicer 10 includes a suspension system including one or more suspension components (e.g., shocks, dampers, springs, etc.) positioned between the frame 12 and one or more components (e.g., tractive elements, axles, etc.) of the front tractive assembly 56 and/or the rear tractive assembly 58. In some embodiments, the deicer 10 does not include the suspension system.

According to an exemplary embodiment, the braking system 60 includes one or more braking components (e.g., disc brakes, drum brakes, in-board brakes, axle brakes, one or more regenerative braking motors, etc.) positioned to facilitate selectively braking one or more components of the driveline 50. In some embodiments, the one or more braking components include (i) one or more front braking components positioned to facilitate braking one or more components of the front tractive assembly 56 (e.g., the front axle, the front tractive elements, etc.) and (ii) one or more rear braking components positioned to facilitate braking one or more components of the rear tractive assembly 58 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the braking system 60 is configured to facilitate braking one or more components of the driveline 50 responsive to an input received from the first operator controls 40. By way of example, responsive to interfacing with (e.g., engaging, depressing, pushing, etc.) the brake 46, the braking system 60 may be configured to facilitate braking one or more components of the driveline 50. By way of another example, responsive to interfacing with (e.g., engaging, pressing, turning, pulling, etc.) one or more input devices, the braking system 60 may be configured to engage a parking brake to brake the front tractive elements and/or the rear tractive elements. In such an example, responsive to engaging the parking brake, the one or more displays may provide an indication (e.g., flash a light, play a sound, display a message, play a message, etc.) that the parking brake is engaged.

### De-Icing System

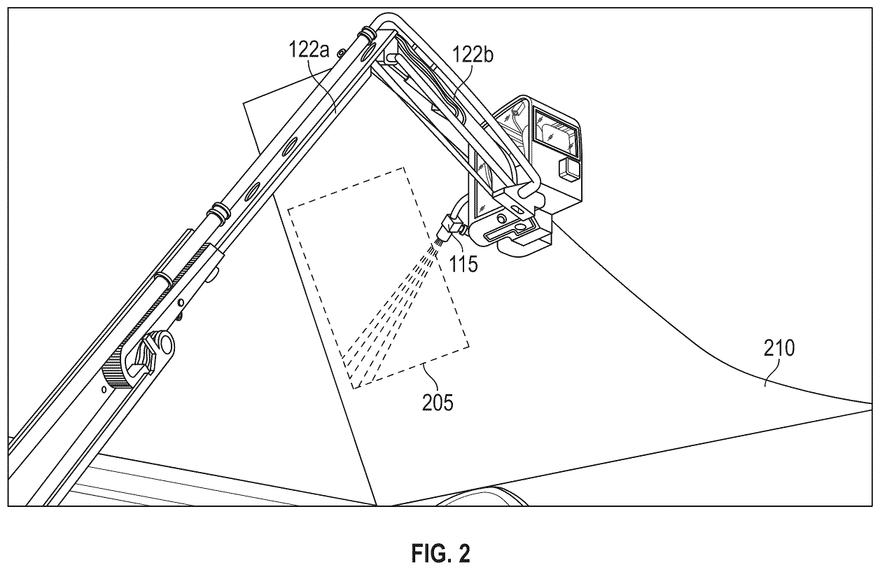

As shown in FIGS. 1 and 2, the de-icing system 100 includes an operator control area (e.g., aerial cab, bucket, basket, platform, etc.), shown as bucket assembly 105, a dispensing system, shown as sprayer assembly 110, a boom assembly, shown as arm assembly 120, a conduit system, shown as tubing assembly 130, a rational coupler, shown as turntable 140, and a sensor system, shown as vision system 150. The arm assembly 120 includes one or more arms, shown as first arm 122a and second arm 122b. In some embodiments, the first arm 122a is a telescoping arm. According to an exemplary embodiment, the second arm 122b is pivotably coupled to the first arm 122a such that the second arm 122b moves and/or articulates relative to the first arm 122a. As shown in FIG. 1, the turntable 140 is pivotably coupled to the body 20 and/or the frame 12 and the proximal end of the first arm 122a of the arm assembly 120 is pivotably coupled or movably coupled to the turntable 140. As shown in FIGS. 1 and 2, the bucket assembly 105 is coupled to a distal end of the second arm 122b and the sprayer assembly 110 is coupled to the bucket assembly 105 (e.g., a front end thereof). According to an exemplary embodiment, the de-icing system 100 includes a plurality of actuators configured to rotate the turntable 140, pivot the first lift arm 122a relative to the turntable 140, extend the first lift arm 122a, pivot the second arm 122b relative to the first arm 122a, pivot the bucket assembly 105, and/or manipulate the sprayer assembly 110. As shown in FIG. 1, the tubing assembly 130 extends from the sprayer assembly 110, along the arm assembly 120, and into the body 20. According to an exemplary embodiment, the deicer 10 includes (a) a storage tank or reservoir positioned within the body 20 that stores deicing fluid and is coupled to the tubing assembly 130 and (b) a deicer pump system configured to pump the deicing fluid to the sprayer assembly 110.

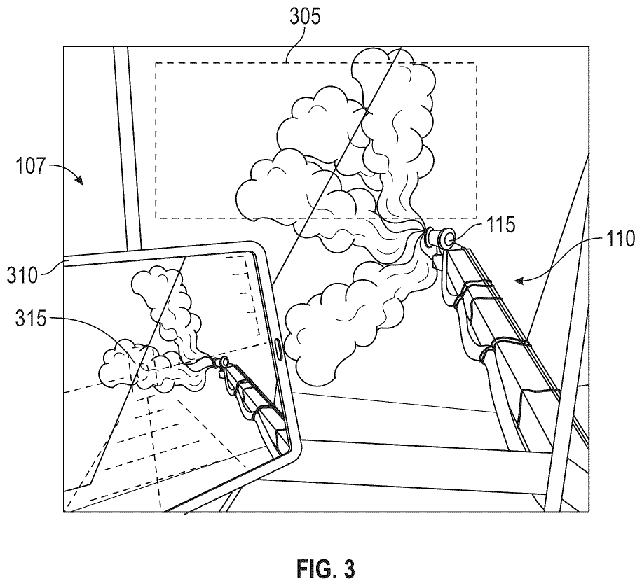

The bucket assembly 105 may refer to and/or include one or more components to hold an operator of the de-icing system 100. For example, the bucket assembly 105 may include a cabin. As shown in FIGS. 1 and 3, the bucket assembly 105 includes operator controls, shown as operator interface 107. According to an exemplary embodiment, the operator interface 107 is configured to provide an operator with the ability to control one or more functions of and/or provide commands to the deicer 10, the de-icing system 100, and the components thereof (e.g., turn on, turn off, engage various operating modes, raise/lower the de-icing system 100, operate the sprayer assembly 110, the operate the deicer 10, etc.). The operator interface 107 may include one or more displays and one or more input devices. The one or more displays may be or include a touchscreen, an LCD display, a LED display, a speedometer, gauges, warning lights, etc. The one or more displays are configured to display information and/or warnings relating to the operation of the deicer 10. The one or more input devices may be or include buttons, switches, knobs, levers, dials, joysticks, etc.

In some embodiments, the bucket assembly 105 rotates, pivots, and/or otherwise moves relative to the second arm 122b such that the bucket assembly 105 may change position while a position of the second arm 122b may be maintained. Additionally and/or alternatively, the bucket assembly 105 moves relative to the deicer 10 (e.g., the body 20, the frame 12, etc.) such that the bucket assembly 105 can rotate about and/or around the deicer 10 (e.g., via the turntable 140). In some embodiments, the bucket assembly 105 may be raised and/or lowered such that the height and/or altitude of the bucket assembly 105 may change relative to the deicer 10 and the ground.

In some embodiments, the sprayer assembly 110 is coupled to the bucket assembly 105 such that the sprayer assembly 110 is at least partially visible from within the cabin of the bucket assembly 105. As shown in FIGS. 1-3, the sprayer assembly 110 includes a fluid output or dispenser, shown as nozzle 115, which is configured to project and/or discharge the de-icing liquid from the deicer 10. For example, the nozzle 115 may include one or more valves or dampers that move based on one or more signals provided from the operator interface 107 and/or the controller 170. Stated otherwise, the nozzle 115 is controllable via the operator interface 107 and/or the controller 170 such that a projection angle, a launch angle, direction, pressure, etc. of liquid from the nozzle 115 is controlled by the operator interface 107 and/or the controller 170.

As shown in FIG. 1, the vision system 150 is coupled to and/or disposed on the bucket assembly 105. The vision system 150 may refer to and/or include at least one of cameras, sensors, machine vision components, accelerometers, gyroscopes, radar systems, LIDAR systems, tracking equipment, and/or other possible object detection systems. The vision system 150 may include one or more components that are variously positioned about the deicer 10 to acquire vehicle information or vehicle data regarding operation of the deicer 10, placement of an airplane, and/or a surrounding environment. The vision system 150 may refer to and/or include at least one spray assist system to assist with the operation of the sprayer assembly 110 and/or the application of deicing liquids.

In some embodiments, the vision system 150 includes cameras that are configured to capture image data including videos and/or still images and radar and/or LIDAR sensors that are configured to capture distance measurements, three-dimensional maps, perform object detection and recognition, and/or capture other radar/LIDAR data. The image data from the cameras and the radar/LIDAR data from the radar and/or LIDAR sensors may be transmitted to the operator interface 107 to be displayed on the one or more displays thereof. According to an exemplary embodiment, one or more of the cameras, the radar sensors, and/or the LIDAR sensors are configured to facilitate obtaining data relating to the airplane and one or more components thereof including a position of the airplane relative to the deicer 10, a position of a tail wing and/or side wings relative to the de-icing system 100 (e.g., a vertical and/or horizontal displacement between the tail wing, the side wings, and the de-icing system 100, an orientation of the de-icing system 100 relative to the tail wing and/or the side wings, etc.), and/or other airplane image data.

According to another exemplary embodiment, one or more of the cameras, the radar sensors, and/or the LIDAR sensors are configured to facilitate obtaining data relating to the operation of the deicer 10 and one or more components thereof including a position of components of the de-icing system 100, the sprayer assembly 110, the arm assembly 120, etc. In some embodiments, the cameras, the radar sensors, and/or the LIDAR sensors are configured to continuously capture data or periodically capture data (e.g., take a picture every 1 second, 5 seconds, 30 seconds, etc., record a 30 second, 1 minute, 5 minute, etc., long video every 30 seconds, 1 minute, 5 minutes, etc., capture data every 1 second, 5 seconds, 30 seconds, etc.).

In some embodiments, the cameras, the radar sensors, and/or the LIDAR sensors are configured to capture data responsive to an event (e.g., a detection that the deicer 10 is proximate to an airplane, a detection that a position of the deicer 10 has changed, etc.) and communicate the data captured before the detection of the event (e.g., 30 seconds before, 1 minute before, 5 minutes before, etc.), after the detection of the event (e.g., 30 seconds after, 1 minute after, 5 minutes after, etc.), and/or during the detection of the event. In some embodiments, the data captured by the vision system 150 is used to autonomously drive the deicer 10, recognize one or more objects (e.g., recognize an operator, recognize a type of airplane, etc.), detect one or more objects or hazards and control one or more components of the deicer 10 to avoid a collision with the hazard or object, assist the operator to perform one or more functions (e.g., assist in aligning the sprayer assembly 110 with an airplane, assist in moving and/or adjusting the bucket assembly 105), and/or for one or more other processes.

In some embodiments, the controller 170 and/or the vision system 150 (e.g., the cameras, the radar sensors, and/or the LIDAR sensors) located on the deicer 10 are used to detect one or more components of the airplane, one or more locations of the components on the airplane, one or more distances between components of the airplane, etc. Components of the airplane detected by the controller 170 and/or the vision system 150 may include, for example, an engine (e.g., a turbine, a jet engine, a propeller, etc.), one or more side wings, a tail wing, a fuselage, landing gear, etc. By way of example, the controller 170 and/or the vision system 150 may detect locations of one or more components relative to a ground level. For example, the controller 170 and/or the vision system 150 may detect a location of the turbine engine, a wing, the fuselage, etc. relative to a ground surface on which the airplane is positioned.

In some embodiments, the controller 170 and/or the vision system 150 may determine a height of various components of the airplane by detecting a location of a component and a location of the ground. In some embodiments, the vision system 150 is configured to perform local processing of the data captured thereby to detect the type of the component, locations thereof, height thereof, etc. In some embodiments, the vision system 150 is configured to transmit the data acquired thereby to a controller (e.g., the controller 170), which may be configured to use the data to determine the type of the component, locations thereof, height thereof, etc. For example, the vision system 150 may transmit data regarding the engine of the airplane to the controller 170, and the controller 170 may identify the type of engine and/or the height of the engine. In various embodiments, the vision system 150 may be configured to determine or detect a location or position of one or more components of the airplane relative to a location or position of the deicer 10 and/or one or more components of the deicer 10. For example, the vision system 150 can determine a position of the sprayer assembly 110 with respect to an area of an airplane

In some embodiments, the vision system 150 may be configured to capture distance measurements, capture three-dimensional maps, perform or facilitate performing (e.g., by the controller 170) object detection and recognition, and/or capture other data. For example, the radar sensors and/or the LIDAR sensors may determine or facilitate determining distances between components of the airplane, determine heights of components, determine shapes, dimensions, areas, etc. of components, and/or characteristics of components. The cameras of the vision system 150 may be configured to capture image data including videos and/or still images. For example, the cameras may capture images or videos of various components of the airplane. The cameras may transmit camera data to the controller 170 to determine information such as component locations relative to other components, component locations relative to the ground, component identification, etc. In some embodiments, the deicer 10 is configured to utilize a combination of the cameras, the radar sensors, and the LIDAR sensors. In various embodiments, the deicer 10 utilizes one or more of the sensors to obtain data relating to one or more components of the airplane to determine an orientation and/or placement of the airplane relative to the deicer 10.

The vision system 150 may be configured to identify or facilitate identifying (e.g., by the controller 170) characteristics of one or more components of the airplane. Different types of airplane may have similar components that may look differently, be positioned differently, etc. For example, the vision system 150 may be positioned to capture or sense the nose landing gear of the airplane. The vision system 150 may then be configured to identify or facilitate identifying (e.g., by the controller 170) specific characteristics of the nose landing gear. The specific characteristics may differentiate the airplane from another airplane. For example, the nose landing gear detected by the vision system 150 may include four wheels, while nose landing gears of different airplanes may include two wheels, six wheels, etc.

The vision system 150 may be configured to detect or facilitate detecting (e.g., by the controller 170) locations of a plurality of components. For example, the vision system 150 may detect the location of a tail wing, a side wing, the fuselage, and the engine of the airplane. The vision system data may be used to calculate distances between the components via, for example, triangulation, which may be used to detect or determine the type of airplane. The vision system 150 may be configured to detect or facilitate detecting (e.g., by the controller 170) a shape of a component. For example, the vision system 150 may identify or facilitate identifying (e.g., by the controller 170) edges, vertices, etc. of a component. Further, the vision system 150 may determine or facilitate determining (e.g., by the controller 170) a length, width, height, etc. of each edge of the component and/or dimensions, area, volume, etc. of the entire shape of the component.

In some embodiments, the vision system 150 and/or the controller 170 are configured to determine a type of airplane using machine vision detection capabilities (e.g., object recognition, machine learning, by comparing real-time images to a database of images, etc.). In some embodiments, the vision system 150 and/or the controller 170 are additionally or alternatively configured to determine a type of airplane using a lookup table. For example, the controller 170 and/or the vision system 150 may be configured to perform calculations to determine heights, distances, sizes, shapes, and/or other measurements of components captured by the vision system 150. The lookup table may then be accessed (e.g., stored on the controller 170 within memory, etc.) by the controller 170 and/or the vision system 150. The lookup table may include information used to determine a type of airplane based on measurements taken by the vision system 150. For example, the lookup table may correlate the type of airplane with a size of one or more components of the airplane. For example, the lookup table may correlate the type of airplane with a component height, relative component distances, a component size, a component shape, etc. of the airplane. As such, the vision system 150 may capture such information for use as an input to the lookup table. The output of the lookup table may be the specific type of airplane being sensed.

While it has been described herein that the controller 170 and/or the vision system 150 perform airplane recognition based on the data acquired using the vision system 150, in some embodiments, a server and/or one or more remote databases may be configured to at least partially perform the airplane recognition processes described herein. For example, the data acquired by the vision system 150 may be transmitted to a server, and the server may be configured to perform the airplane recognition procedures and then transmit the type of airplane to the deicer 10.

In some embodiments, the deicer 10 is additionally or alternatively configured to acquire automatic dependent surveillance-broadcast (ADS-B) data provided by one or more servers and/or remote devices regarding one or more airplanes to perform airplane recognition. For example, the server may be an ADS-B system that monitors the positioning of airplanes (e.g., based on satellite data or other sensors). The controller 170 may be configured to access the ADS-B data from the server. In some embodiments, the ADS-B data is continuously obtained by the controller 170. In some embodiments, the ADS-B data is acquired when an airplane is detected and/or identified by the controller 170 and/or the vision system 150. The ADS-B data may be used to determine a type of airplane or confirm the type of airplane detected by the controller 170 and/or the vision system 150. For example, a location of the deicer 10 may be obtained or determined by the controller 170. The controller 170 may then acquire and/or use the ADS-B data to identify an airplane at or near the location of the deicer 10. Thus, the controller 170 can determine the type of airplane that the detected airplane is by searching for or otherwise identifying, using the ADS-B data, an airplane located near the location of the deicer 10. The ADS-B data may include information used to identify the type of airplane in addition to a location of the airplane, such as a make and model of the airplane. In various embodiments, the ADS-B data may include a plurality of airplanes located near the deicer 10. The controller 170 may select or identify the airplane nearest the location of the deicer 10.

In some embodiments, the ADS-B data is used in conjunction with the data obtained by the vision system 150 to confirm an identification of a type of airplane. For example, the controller 170 and/or the vision system 150 may determine information relating to one or more components of the airplane to determine that the airplane is a first type of airplane. The controller 170 may then acquire and/or utilize ADS-B data to identify an airplane at or near a location of the deicer 10 to confirm the type of airplane determined using the vision system 150. As such, ADS-B data may be used to confirm the recognition of the type of airplane by the vision system 150. In other embodiments, the vision system 150 is used to confirm recognition of the airplane using the ADS-B data. For example, the ADS-B data may be used to identify, using location data, a type of airplane near a location of the deicer 10. The vision system 150 may identify one or more components of the airplane to confirm the identification made using the ADS-B data.

In some embodiments, the controller 170 is configured to acquire the type of airplane from the server and/or determine the type of airplane based on data measured by the sensors of the vision system 150. In general, the controller 170 may be configured to assist an operator of the deicer 10 based the type of airplane. It should be appreciated that the assistance and control of the deicer 10 described herein as being performed by the controller 170 may also be performed by a server and/or remote device, which provides the control signals to assist an operator to the controller 170. As described herein, the type of airplane may include identification information relating to the size, shape, location, and components of the airplane, and the size, shape, location, orientation, height above the ground, and quantity of components on the airplane (e.g., engine(s), wings, fuselage, nose landing gear, main landing gear, etc.).

In some embodiments, the controller 170 is configured to utilize the identification information provided by the type of airplane to assist the deicer 10 in approaching and/or servicing (e.g., deicing) an airplane and/or navigating proximate to the airplane to align the deicer 10 with one or more portions of the airplane. For example, the controller 170 may generate or modify a steering command (e.g., change a steering angle or travel direction of the deicer 10) provided to the driveline 50 by the operator interface 107. In some embodiments, the controller 170 may generate or modify a steering command to guide the deicer 10 so that the sprayer assembly 110 is aligned with a portion of the airplane (e.g., wing, tail wing, fuselage, etc.), based on a known location of the portion and/or sprayer assembly 110. In some embodiments, alternatively or additionally, the controller 170 is configured to generate or modify a steering command to avoid components of the airplane based on the size, shape, location, orientation, and/or height above the ground of the components provided in the identification information. For example, if the deicer 10 is on a path that would bring the deicer 10 too close to the engine of an airplane, the controller 170 may generate or modify a steering command that steers the deicer 10 away from the engine.

In some embodiments, the controller 170 may be configured to generate or modify a speed command provided to the front tractive assembly 56 and/or the rear tractive assembly 58 by the prime mover 52 based on the identification information. For example, a turn radius of the deicer 10 may be impacted based on a position of the bucket assembly 105 relative to the deicer 10, and the identification information may include or indicate the dimensions of the airplane such that the deicer 10 may avoid the airplane. In some embodiments, the controller 170 may be configured to generate or modify a brake command provided to the braking system 60 based on the identification information. For example, the deicer 10 may take a longer time to stop or slow down when the bucket assembly 105 is raised and/or elevated relative to the deicer 10, so the identification information may include a brake force threshold that is based on the height of the bucket assembly 105. In some embodiments, the controller 170 may be configured to generate or modify a steering command provided to the driveline 50 based on the identification information. For example, the identification information may include a steering angle threshold that is based on a position of the arms 122. Alternatively or additionally, the size, shape, location, orientation, height above the ground, and quantity of components on an airplane (e.g., engine(s), wings, fuselage, nose landing gear, main landing gear, etc.) provided in the identification information may be utilized by the controller 170 to generate or modify the steering command to avoid contacting the components on the airplane (e.g., obstacles). For example, the deicer 10 may perform different steering performance when navigating proximate to an airplane with a larger wingspan than an airplane with a smaller wingspan, and the identification information may generate or modify the steering command based on the type of airplane.

### Spray Assist System

FIG. 2 depicts a perspective view of the deicer 10 clearing ice from a portion of an airplane. As shown in FIG. 2, the nozzle 115 is discharging de-icing fluid from the deicing tank of the deicer 10 onto a tail wing 210 of the airplane. In some embodiments, the vision system 150 is configured to detect and/or identify an area 205 of the airplane, in this instance the area 205 is at least a part of the tail wing 210. For example, the vision system 150 may obtain image data and detect, via the image data, a portion and/or surface of the tail wing 210 that is receiving the de-icing liquid. In some embodiments, the vision system 150 is configured to determine and/or detect a position of the deicer 10 and/or one or more components thereof (e.g., the bucket assembly 105) relative to the airplane and/or one or more components thereof. For example, the vision system 150 may determine an orientation of the nozzle 115 relative to the tail wing 210. As another example, the vision system 150 may determine a horizontal distance between the sprayer assembly 110 and the area 205.

In some embodiments, the vision system 150 and/or the controller 170 are configured to implement and/or otherwise provide a feedback system to enhance accuracy or performance of the operation of the de-icing system 100. For example, the vision system 150 may monitor discharging of the de-icing liquid from the nozzle 115 to ensure that the de-icing liquid is hitting an intended target (e.g., an airplane and/or one or more components thereof). As another example, the vision system 150 may capture image data associated with the front end 22 such that data of the nozzle 115 may be obtained. In some embodiments, the vision system 150 and/or the controller 170 may prevent over spraying (e.g., over application of de-icing liquid and/or missing an intended target) by the sprayer assembly 110. For example, the vision system 150 may detect one or more areas of an airplane to generate a virtual and/or simulated environment to assist an operator with aligning and/or manipulating the sprayer assembly 110 to ensure that the de-icing liquid reaches an intended target (e.g., the tail wing 210, a fuselage, a wing, etc.). As another example, the vision system 150 may produce and/or otherwise provide a heads up display and/or heads up environment to supplement and/or improve a field of view from the bucket assembly 105. As yet another example, the vision system 150 and/or the controller 170 may be configured to prevent movement of the turntable 140, the arm assembly 120, the bucket assembly 105, and/or the sprayer assembly 110 when an overspray condition is detected or anticipated. As still another example, the vision system 150 and/or the controller 170 may be configured to provide haptic, audible, or visual feedback to notify an operator when an overspray condition is detected or anticipated so that the operator can take corrective actions. All such actions of the vision system 150 and/or the controller 170 may take into account (a) external characteristics such as temperature, wind speed, distance between the nozzle 115 and the portion of the airplane being de-iced, orientation of the nozzle 115 relative to the portion of the airplane being de-iced, etc. and/or (b) internal characteristics such as fluid pressure, fluid flow rate, deicer pump speed, etc.

FIG. 3 depicts a field of view from within the bucket assembly 105, according to an exemplary embodiment. As shown in FIG. 3, the bucket assembly 105 includes a field of view 305, which is shown to include and/or capture a view in front of and/or proximate to the bucket assembly 105. In some embodiments, the field of view 305 may refer to and/or include a view visible to an operator of the deicer 10 and/or the sprayer assembly 110 while seated and/or positioned within the bucket assembly 105. In some embodiments, the bucket assembly 105 includes one or more display devices, shown as display device 310 in FIG. 3, to present a user interface (e.g., user interface 315).

In some embodiments, the field of view 305 may refer to or include a point of view from within the bucket assembly 105. For example, the field of view 305 includes a point of view of an operator that is looking out from the bucket assembly 105. The field of view 305 can be different that one or more point of views from one or more components of the vehicle 10. For example, the nozzle 115 may include a point of view (e.g., a view from or at the nozzle 115) that is different from or offset from the point of view within the bucket assembly 105. The user interface 315 can provide a graphical representation that is from the vantage point of the field of view 305. For example, the user interface 315 can present or display an illustrated version or graphic of the field of view 305. As another example, the point of view from the nozzle 115 (or other component from the vehicle 10) can be omitted or otherwise absent from the user interface 315.

In some embodiments, the user interface 315 includes and/or displays information collected by the vision system 150. For example, the user interface 315 may include image data captured by the vision system 150. In some embodiments, the user interface 315 refers to and/or includes a virtual representation of the environment of the deicer 10. For example, as shown in FIG. 3, the user interface 315 includes a digital (e.g., a virtual) representation of the sprayer assembly 110 in space. In some embodiments, the user interface 315 includes one or more graphics, icons, displays, and/or elements to assist in alignment of the sprayer assembly 110. For example, as shown in FIG. 3, the user interface 315 includes reticles and/or lines that represent where de-icing liquid would travel based on a current position and/or orientation of the deicer 10 and/or one or more components thereof (e.g., the arms 122, the turntable 140, the bucket assembly 105, and/or the sprayer assembly 110) to help guide an operator to prevent an overspray condition. The elements (e.g., the reticles) can be overlayed on top of the image (e.g., the field of view 305) to indicate where the sprayer assembly 110 will spray. Such a display may take into account (a) external characteristics such as temperature, wind speed, distance between the nozzle 115 and the portion of the airplane being de-iced, orientation of the nozzle 115 relative to the portion of the airplane being de-iced, etc. and/or (b) internal characteristics such as fluid pressure, fluid flow rate, deicer pump speed, etc.

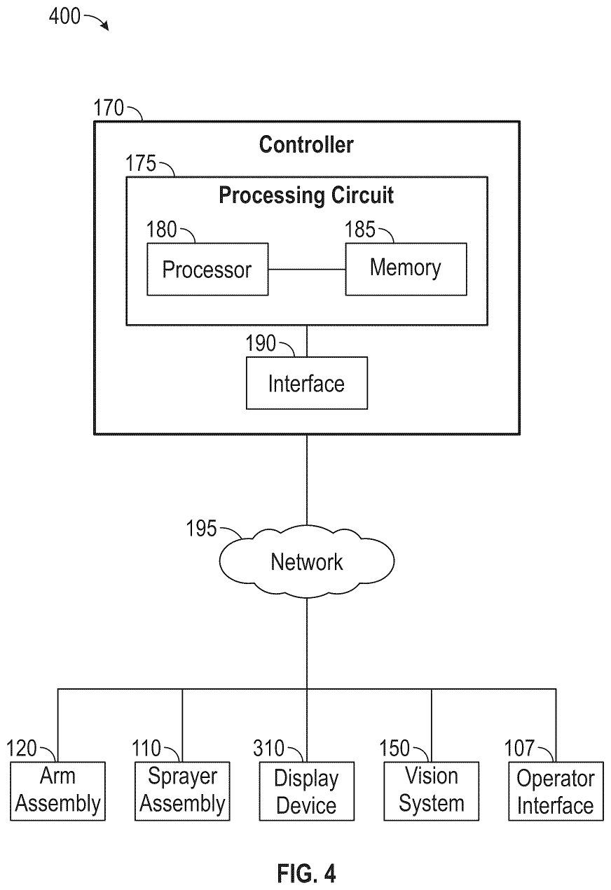

FIG. 4 is a block diagram of a control system 400 to control operation of the deicer 10, according to an exemplary embodiment. In some embodiments, the control system 400 includes one or more components of the deicer 10. For example, as shown in FIG. 4, the control system 400 includes the controller 170, the arm assembly 120, the sprayer assembly 110, the vision system 150, the operator interface 107, and the display device 310. In some embodiments, the one or more components of the control system 400 are communicably coupled via network 195. The network 195 may include at least one of a controller area network (CAN), a local area network (LAN), a cellular network, a wide area network (WAN), wired communication, wireless communication, and/or otherwise possible network connections.

As shown in FIG. 4, the controller 170 includes a processing circuit 175 and an interface 190. The processing circuit 175 includes a processor 180 and a memory 185. The interface 190 communicably couples the controller 170 with one or more components of the control system 400. For example, the interface 190 may communicably couple the controller 170 with the vision system 150 such that one or more signals may be exchanged between the controller 170 and the vision system 150. In some embodiments, the vision system 150 acquire information from one or more components of the control system 400 via the network 195. For example, the vision system 150 may acquire control signals from the operator interface 107. As another example, the vision system 150 may monitor discharge of de-icing liquid from the sprayer assembly 110.

In some embodiments, the controller 170 tracks a position of the sprayer assembly 110. For example, the controller 170 may monitor control signals provided to the sprayer assembly 110, the bucket assembly 105, the arm assembly 120, the turntable 140, etc. to track changes to the position of the sprayer assembly 110. As another example, the controller 170 may communicate with first devices coupled with the sprayer assembly 110 and second devices coupled with stationary portions of the deicer 10 to determine a position of the sprayer assembly 110 (e.g., using triangulation techniques).

In some embodiments, the controller 170 receives one or more sets of data. For example, the controller 170 may receive data that indicates a position of the sprayer assembly 110. As another example, the controller 170 may receive image data and then determine, based on the image data, a position of the sprayer assembly 110. In some embodiments, the controller 170 determines a placement in space of the sprayer assembly 110. For example, the controller 170 may determine a horizontal distance between the sprayer assembly 110 and the tail wing 210. As another example, the controller 170 may determine an angular orientation between the sprayer assembly 110 and the tail wing 210.

In some embodiments, the position of the sprayer assembly 110 can include at least one of an orientation of the nozzle 115, an amount of extension of the lift arms (e.g., arm 122a, arm 122b, etc.), or a vertical height of the nozzle 115. For example, the controller 170 can determine the position of the sprayer assembly 110 by monitoring or tracking rotation or adjustments to the nozzle 115 which affect an orientation of the nozzle 115 (e.g., where the nozzle 115 is pointing). As another example, the controller 170 can determine the position of the sprayer assembly 110 by tracking extension of the lift arms 122 to track a height of the bucket assembly 105 or the sprayer assembly 110. As another example, the controller 170 can determine the position of the sprayer assembly 110 by monitoring or tracking changes to an elevation of the nozzle 115 (e.g., a vertical distance with respect to a ground surface).

In some embodiments, the controller 170 causes a user interface to be presented. For example, the controller 170 may cause the user interface 315 to be displayed. In some embodiments, the controller 170 causes the user interface 315 to be displayed by transmitting one or more signals to the display device 310, which causes the display device 310 to present the user interface 315. For example, the controller 170 may transmit image data, via the network 195, to cause the display device 310 to display the image data (e.g., the user interface 315).

In some embodiments, the user interface 315 includes one or more graphical representations. For example, the user interface 315 may display a digital image and/or virtual image of the sprayer assembly 110. As another example, the user interface 315 may display an image or camera feed of the vision system 150. In some embodiments, the user interface 315 includes elements to assist in alignment of the sprayer assembly 110. For example, the user interface 315 may include reticles to illustrate a current alignment of the sprayer assembly 110 (e.g., where the sprayer assembly 110 is currently pointing, what the sprayer assembly 110 is aimed at, where the deicer fluid is projected to hit the airplane based on external and internal characteristics, etc.).

In some embodiments, one or more movements of the sprayer assembly 110 can occur without an adjustment to the field of view 305. For example, a side-to-side movement of the nozzle 115 may occur without any movement by the bucket assembly 105. As a result, the field of view 305 may be maintained even though the position of the sprayer assembly 110 (e.g., the nozzle 115) has changed. As another example, the sprayer assembly 110 may move closer to or further away from an airplane without changing the field of view 305.

In some embodiments, the controller 170 may continuously or semi-continuously monitor statuses of one or more components of the vehicle 10. For example, the controller 170 may monitor statuses to detect movement of the sprayer assembly 110. As another example, the controller 170 may monitor statuses to detect movement of the arms 122. In some embodiments, one or more movements of components (of the vehicle 10) can result in an update to one or more user interfaces. For example, the controller 170 may update the user interface 315 to adjust a position or location of the reticles to indicate a change in the location for where the sprayer assembly 110 will spray.

In some embodiments, the controller 170 may detect one or more selections of a portion of an airplane. For example, the controller 170 may monitor interactions with the user interface 315 to detect if certain areas, regions, or portions of an airplane are selected. As another example, the controller 170 may update the user interface 315 to display one or more prompts to select an area of an airplane. The controller 170 may detect the selection based on an interaction with the prompts. In some embodiments, the controller 170 may autonomously control one or more components of the vehicle 10 to position the sprayer assembly 110 such that the sprayer assembly 110 will spray on the selected portion. For example, the controller 170 may activate the turntable 140 to adjust a position of the bucket assembly 105 or the sprayer assembly 110 such that the sprayer assembly 110 is aligned with the selected portion. As another example, the controller 170 may extend or retract the lift arms 122 to adjust a vertical height of the sprayer assembly 110 or a distance between the sprayer assembly 110 and the selected portion.

In some embodiments, the controller 170 may detect one or more amounts of the de-icing liquid that is reaching an area of an airplane. For example, the vision system 150 may collected one or more sets of data which indicate an amount of liquid that is reaching the airplane. The controller 170 may track the amounts of liquid that is reaching the airplane during operation of the sprayer assembly 110. In some embodiments, the controller 170 may detect that an amount of liquid that is reaching the airplane is less than a predetermined threshold. For example, the controller 170 may detect that some liquid is missing an intended portion or area of the airplane. As another example, the controller 170 may detect that wind is adjusting a flight path of the liquid such that some liquid is being redirected.

In some embodiments, the controller 170 can update the user interface 315 to include one or more elements that display a prompt or message to indicate that the amount of liquid reaching the area is less than the threshold. For example, the controller 170 may update the user interface 315 to include a banner or overlay that is presented on top of the reticles to indicate the amount of liquid reaching the airplane is below the threshold. As another example, the controller 170 may update the user interface to include a message to redirect or adjust the position of the sprayer assembly 110. In some embodiments, the controller 170 may prevent subsequent application of the de-icing liquid. For example, the controller 170 may autonomously shut off a supply of the liquid to the sprayer assembly 110 responsive to detecting the amount of liquid reaching the airplane is below the threshold. The controller 170 may prevent application of the de-icing liquid to conserve an amount of remaining liquid. In some embodiments, the controller 170 may prevent the application of the de-icing liquid without any input from the operator or display device 310. Stated otherwise, the controller 170 may implement one or more autonomous control steps.

In some embodiments, the controller 170 may track one or more amounts of time that elapse while the de-icing liquid is being applied to the airplane. For example, upon initiation or activation of the nozzle 115 (e.g., spraying the de-icing liquid), the controller 170 may track an amount of time that is spent (e.g., elapsed) applying the de-icing liquid to a given portion, region, or area of the airplane. In some embodiments, the controller 170 may detect that an amount of time exceeds a threshold. For example, the controller 170 may detect that an amount of time spraying the de-icing liquid on a wing of the airplane exceeds a threshold. Stated otherwise, the controller 170 may detect that a given portion, area, region, or component of the airplane is being over-sprayed.

In some embodiments, the controller 170 may update the user interface to include one or more elements which indicate that the amount of time (spent on the region, area, component, etc. of the airplane) exceeds the threshold. For example, the controller 170 may update the user interface 315 to include a banner which indicates that a wing of the airplane is being over-sprayed. In some embodiments, the controller 170 may implement autonomous control of one or more components of the vehicle 10 to reposition the sprayer assembly 110. For example, the controller 170 may activate the turntable 140 to rotate the nozzle 115 such that a different portion of the airplane receives the de-icing liquid. As another example, the controller 170 may lower the lift arms 122 to adjust a height of the nozzle 115.

In some embodiments, the controller 170 may receive one or more sets of data that pertain to the airplane. For example, the controller 170 may receive data regarding an area of the airplane (e.g., a wing, a tail, etc.). The data include a wind direction and a wind speed. Stated otherwise, the data may include measurements of one or more environmental conditions proximate to the airplane. In some embodiments, the controller 170 may generate one or more predictions regarding where the de-icing liquid will spray using the data. For example, the controller 170 may predict an impact that the wind direction may have on a flight path of the de-icing liquid as the de-icing liquid travels from the nozzle 115. The controller 170 may generate the predictions prior to the application of the de-icing liquid.

In some embodiments, the controller 170 may update the predictions (e.g., where the de-liquid will spray) based on one or more detected operating characteristics of the sprayer assembly 110. For example, the controller 170 may update the predictions based on fluid pressure detected within the sprayer assembly 110. As another example, the controller 170 may update the predictions based on exit velocity of the de-icing liquid from the nozzle 115. In some embodiments, the controller 170 may update the graphical representation of where the sprayer assembly 110 will spray the de-icing liquid to reflect the prediction having been updated. For example, the controller 170 may change the prediction regarding where the de-icing liquid will spray and based on the change to the prediction, the controller 170 may adjust a position or placement of the reticles within the user interface 315.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled,” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the deicer 10 and the systems and components thereof as shown in the various exemplary embodiments is illustrative only. Additionally, any element disclosed in one embodiment may be incorporated or utilized with any other embodiment disclosed herein.

1. A vehicle for de-icing an airplane, the vehicle comprising:
a chassis;
a body supported by the chassis;
a tractive assembly;
a sprayer assembly configured to apply a de-icing liquid to the airplane;
one or more sensors configured to acquire data regarding an area of the airplane;
a display device; and
a controller configured to:
determine a position of the sprayer assembly relative to the area of the airplane; and
cause the display device of the vehicle to present a user interface that includes a graphical representation of where the sprayer assembly will spray the de-icing liquid based on the position of the sprayer assembly relative to the area of the airplane.

2. The vehicle of claim 1, wherein:
the vehicle has a first point of view from a nozzle of the sprayer assembly;
the vehicle has a second point of view from within the vehicle or a bucket assembly of the vehicle, the second point of view offset from the first point of view; and
the graphical representation is from a vantage point of the second point of view and not the first point of view.

3. The vehicle of claim 1, wherein the position of the sprayer assembly includes (i) an orientation of a nozzle of the sprayer assembly with respect to the area of the airplane, (ii) an amount of extension of one or more lift arms of the vehicle coupled with the sprayer assembly, and (iii) a vertical height of the nozzle with respect to a ground surface.

4. The vehicle of claim 1, wherein:
the graphical representation includes:
an image of a view from within the vehicle or a bucket assembly of the vehicle; and
one or more elements overlayed on top of the image to indicate where the sprayer assembly will spray; and
the controller is configured to:
detect one or more movements of the sprayer assembly that adjust a position of a nozzle of the sprayer assembly; and
update, responsive to detection of the one or more movements, the one or more elements to indicate a change in where the sprayer assembly will spray.

5. The vehicle of claim 4, wherein the one or more movements of the sprayer assembly occur without an adjustment to the view from within the vehicle or the bucket assembly.

6. The vehicle of claim 1, wherein the graphical representation includes a view of the area of the airplane, and wherein the controller is configured to:
detect, responsive to one or more interactions with the user interface, a selection of a portion of the area of the airplane; and
autonomously control at least one of the sprayer assembly, a turntable of the vehicle, or a lift arm of the vehicle to position the sprayer assembly such that the sprayer assembly will spray the de-icing liquid on the portion.

7. The vehicle of claim 1, wherein the controller is configured to:
detect, based on one or more sets of data received from the one or more sensors, responsive to application of the de-icing liquid to the airplane, that an amount of the de-icing liquid reaching the area of the airplane is less than a predetermined threshold;
update the user interface to include an element to indicate that the amount of the de-icing liquid reaching the area of the airplane is less than the predetermined threshold; and
prevent, without an input from a computing device or an operator of the vehicle, subsequent application of the de-icing liquid to the airplane.

8. The vehicle of claim 1, wherein the controller is configured to:
track, responsive to application of the de-icing liquid to the airplane, an amount of time elapsed while applying the de-icing liquid to a first portion of the airplane;
detect that the amount of time exceeds a predetermined threshold;
update the user interface to include an element to indicate that the amount of time exceeds the predetermined threshold; and
autonomously control at least one of the sprayer assembly, a turntable of the vehicle, or a lift arm of the vehicle to reposition the sprayer assembly to spray the de-icing liquid on a second portion of the airplane different than the first portion.

9. The vehicle of claim 1, wherein the controller is configured to:
acquire, from the one or more sensors, the data regarding the area of the airplane, wherein the data includes a wind direction and a wind speed;
generate, prior to application of the de-icing liquid, a prediction as to where the de-icing liquid will travel using the data regarding the area of the airplane;
update, responsive to application of the de-icing liquid, the prediction based on one or more detected operating characteristics of the sprayer assembly; and
cause the graphical representation to be updated to reflect the prediction having been updated.

10. A vehicle comprising:
a turntable;
a lift arm movably coupled with the turntable;
a sprayer assembly movably coupled with the lift arm, the sprayer assembly configured to apply a de-icing liquid to an airplane; and
a controller configured to:
determine a position of the sprayer assembly relative to an area of the airplane; and
cause a display device to present a user interface that includes a graphical representation of where the sprayer assembly will spray the de-icing liquid based on the position of the sprayer assembly relative to the area of the airplane.

11. The vehicle of claim 10, further comprising:
a first point of view from a nozzle of the sprayer assembly laterally offset from a second point of view from within the vehicle or a bucket assembly of the vehicle, and the second point of view different than the first point of view; and
the graphical representation included in the user interface presented by the display device to illustrate where the sprayer assembly will spray without illustration of the first point of view.

12. The vehicle of claim 10, wherein the position of the sprayer assembly including (i) an orientation of a nozzle of the sprayer assembly with respect to the area of the airplane, (ii) an amount of extension of the lift arm, and (iii) a vertical height of the nozzle with respect to a ground surface.

13. The vehicle of claim 10, wherein:
the graphical representation includes:
an image of a view from within the vehicle or a bucket assembly of the vehicle; and
one or more elements overlayed on top of the image to indicate where the sprayer assembly will spray; and
the controller is configured to:
detect one or more movements of the sprayer assembly that adjust a position of a nozzle of the sprayer assembly; and
update, responsive to detection of the one or more movements, the one or more elements to indicate a change in where the sprayer assembly will spray.

14. The vehicle of claim 13, wherein the one or more movements of the sprayer assembly occur without an adjustment to the view from within the vehicle or the bucket assembly.

15. The vehicle of claim 10, wherein the graphical representation includes a view of the area of the airplane, and wherein the controller is further configured to:
detect, responsive to one or more interactions with the user interface, a selection of a portion of the area of the airplane; and
autonomously control at least one of the sprayer assembly, the turntable of the vehicle, or the lift arm of the vehicle to position the sprayer assembly such that the sprayer assembly will spray the de-icing liquid on the portion.

16. The vehicle of claim 10, wherein the controller is further configured to:
detect, based on one or more sets of data received from one or more sensors of the vehicle, responsive to application of the de-icing liquid to the airplane, that an amount of the de-icing liquid reaching the area of the airplane is less than a predetermined threshold;
update the user interface to include an element to indicate that the amount of the de-icing liquid reaching the area of the airplane is less than the predetermined threshold; and
prevent, without an input from a computing device or an operator of the vehicle, subsequent application of the de-icing liquid to the airplane.

17. The vehicle of claim 10, wherein the controller is further configured to:
track, responsive to application of the de-icing liquid to the airplane, an amount of time elapsed while applying the de-icing liquid to a first portion of the airplane;
detect that the amount of time exceeds a predetermined threshold;
update the user interface to include an element to indicate that the amount of time exceeds the predetermined threshold; and
autonomously control at least one of the sprayer assembly, the turntable of the vehicle, or the lift arm of the vehicle to reposition the sprayer assembly to spray the de-icing liquid on a second portion of the airplane different than the first portion.

18. A de-icing system comprising:
a sprayer assembly movably coupled with a lift arm of a vehicle, the sprayer assembly configured to apply a de-icing liquid to an airplane; and
a controller configured to:
determine a position of the sprayer assembly relative to an area of the airplane; and
cause a display device to present a user interface that includes a graphical representation of where the sprayer assembly will spray the de-icing liquid based on the position of the sprayer assembly relative to the area of the airplane.

19. The de-icing system of claim 18, wherein:
the graphical representation includes:
an image of a view from within the vehicle or a bucket assembly of the vehicle; and
one or more elements overlayed on top of the image to indicate where the sprayer assembly will spray; and
the controller is configured to:
update, responsive to detection of one or more movements of the sprayer assembly, the one or more elements to indicate a change in where the sprayer assembly will spray.

20. The de-icing system of claim 18, wherein the graphical representation includes a view of the area of the airplane, and wherein the controller is further configured to:
detect, responsive to one or more interactions with the user interface, a selection of a portion of the area of the airplane; and
autonomously control at least one of the sprayer assembly, a turntable of the vehicle, or the lift arm of the vehicle to position the sprayer assembly such that the sprayer assembly will spray the de-icing liquid on the portion.
